(19) United States
(12) Patent Application Publication
(10) Pub. No.: US 2011/0279785 A1
(43) Pub. Date: Nov. 17, 2011

(54) PROJECTION DISPLAY DEVICE

(75) Inventors: Toshimasa KANBARA, Osaka (JP); Taichi YOSHIMURA, Osaka (JP); Keiichi SAKASHITA, Osaka (JP); Kouji SHIRAITO, Amagasaki-city (JP)

(73) Assignee: SANYO ELECTRIC CO., LTD., Moriguchi-city (JP)

(21) Appl. No.: 13/107,296

(22) Filed: May 13, 2011

(30) Foreign Application Priority Data
May 13, 2010 (JP) 2010-111111

(51) Int. Cl. G03B 21/16

(52) U.S. Cl. 353/52

(57) ABSTRACT

A projection display device is provided with a main body cabinet including an air inlet; a light source unit which is disposed in the main body cabinet; and a cooling unit which is disposed adjacent to the light source unit, and cools the light source unit. In this arrangement, air drawn to an inside of the main body cabinet through the air inlet is drawn to an inside of the cooling unit, and is supplied to the light source unit. The cooling unit is provided with a filter section which removes unwanted matters from the air drawn to the inside of the cooling unit.

This application claims priority under 35 U.S.C. Section 119 of Japanese Patent Application No. 2010-111111 filed May 13, 2010, entitled “PROJECTION DISPLAY DEVICE”. The disclosure of the above application is incorporated herein by reference.

### BACKGROUND OF THE INVENTION

1. Field of the Invention

The present invention relates to a projection display device for modulating light from a light source by an imager, and enlarging and projecting the modulated light onto a projection plane.

2. Disclosure of Related Art

Conventionally, a projection display device (hereinafter, called as a “projector”) such as a liquid crystal projector is incorporated with a high-luminance light source such as a metal halide lamp or a high pressure mercury lamp. Such a light source is heated to an extremely-high temperature at the time of light emission. In view of this, it is necessary to cool the light source by a cooling device. In this case, there may be used an arrangement, in which air drawn from the outside of the projector is supplied to the light source to cool the light source.

External air is drawn to the inside of a main body cabinet through an air inlet formed in the main body cabinet. A filter is disposed in the air inlet to remove dust and fume from the drawn air.

The air after removal of dust and the like is supplied from the cooling device to the light source. Thus, it is possible to prevent the light source from an influence of dust and the like.

The main body cabinet may be internally provided with a cooling device for cooling an imager such as a liquid crystal panel, and a cooling device for cooling a power source circuit, in addition to a cooling device for cooling a light source.

In the above arrangement, external air to be supplied to all the cooling devices pass through the air inlet of the main body cabinet. As a result, the air intake amount through the air inlet is increased, with the result that the amount of dust and the like to be removed by the filter is increased. In view of this, in the case where a filter is disposed in the air inlet as described in the above arrangement, it is necessary to dispose a large capacity filter, taking into account the life (use time) of the filter.

Further, a projector, which is configured such that an imager liable to be affected by dust is sealably disposed to prevent the imager from direct contact with air, may be put into practice. In the case where the projector has the above arrangement, it is not necessarily required to supply air free of dust and the like to the cooling devices other than the cooling device for the light source. In such a case, use of a large filter in the air inlet is a waste of cost.

### SUMMARY OF THE INVENTION

A projection display device according to a main aspect of the invention is provided with a main body cabinet including an air inlet; a light source unit which is disposed in the main body cabinet; and a cooling unit which is disposed adjacent to the light source unit, and cools the light source unit. In this arrangement, air drawn to an inside of the main body cabinet through the air inlet is drawn to an inside of the cooling unit, and is supplied to the light source unit. The cooling unit is provided with a filter section which removes unwanted matters from the air drawn to the inside of the cooling unit.

### BRIEF DESCRIPTION OF THE DRAWINGS

These and other objects, and novel features of the present invention will become more apparent upon reading the following detailed description of the embodiment along with the accompanying drawings.

FIGS. 1A and 1B are diagrams (perspective views) showing an external construction of a projector embodying the invention.

FIG. 2 is a diagram (bottom view) showing an external construction of the projector as the embodiment.

FIG. 3 is a diagram showing an internal structure of the projector as the embodiment.

FIG. 4 is a diagram schematically showing an arrangement of a projection optical unit in the embodiment.

FIGS. 5A and 5B are diagrams showing an arrangement of a lamp unit and a fan unit in the embodiment.

FIGS. 6A and 6B are diagrams showing the arrangement of the lamp unit and the fan unit in the embodiment.

FIGS. 7A to 7C are diagrams showing an arrangement of a filter unit in the embodiment.

FIG. 8 is a cross-sectional view of the fan unit taken in the horizontal direction at the position of an upper guide piece in the embodiment.

FIGS. 9A and 9B are perspective views of essential parts of the projector in a state that a lamp cover is detached, when viewed from above in the embodiment.

The drawings are provided mainly for describing the present invention, and do not limit the scope of the present invention.

### DESCRIPTION OF PREFERRED EMBODIMENTS

In the following, an embodiment of the invention is described referring to the drawings.

In the embodiment, a filter opening 1d corresponds to an “opening” in the claims. A lamp unit 14 corresponds to a “light source unit” in the claims. A fan unit 16 corresponds to a “cooling unit” in the claims. The description regarding the correspondence between the claims and the embodiment is merely an example, and the claims are not limited by the description of the embodiment.

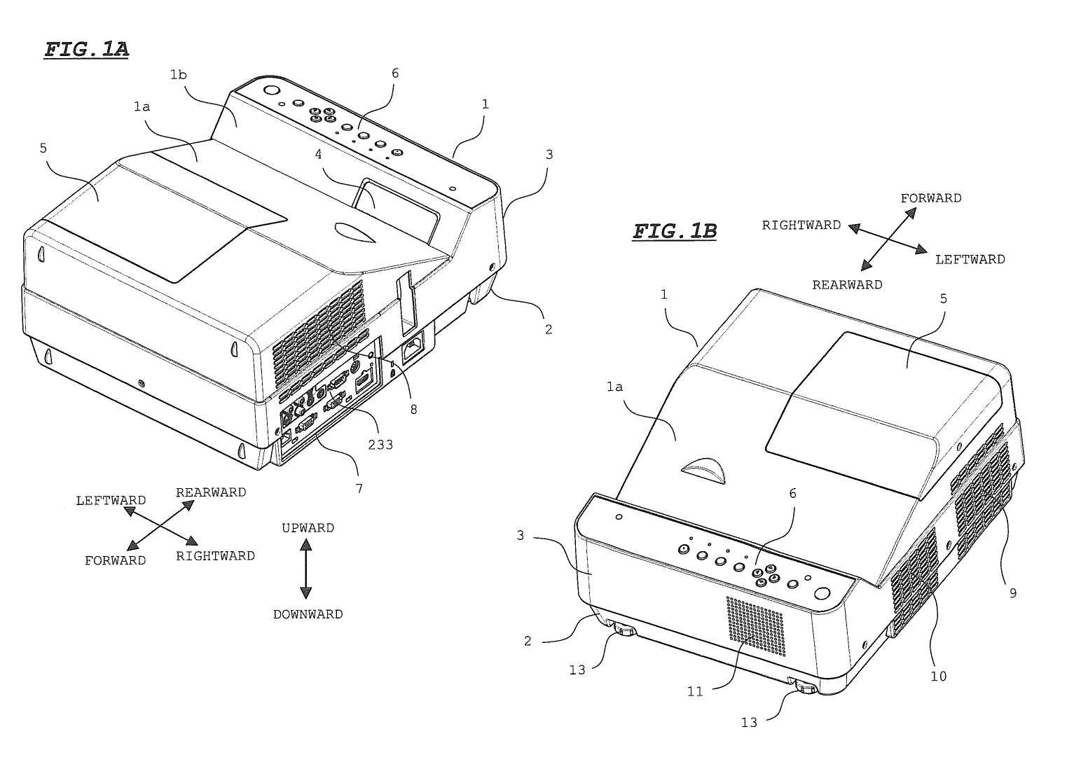

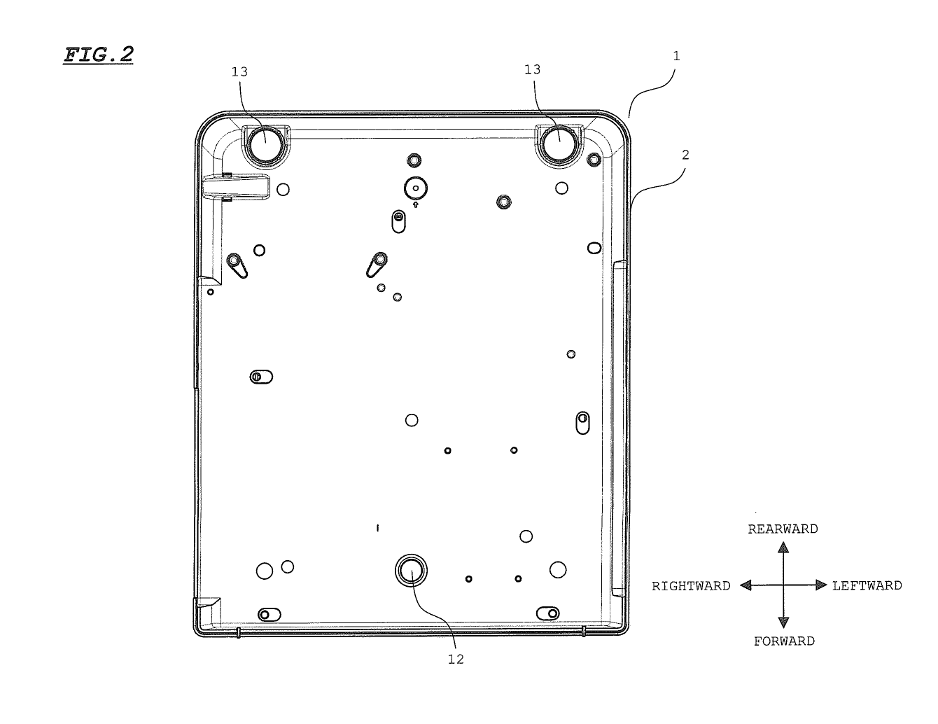

FIGS. 1A, 1B and FIG. 2 are diagrams showing an external construction of a projector embodying the invention. FIG. 1A is a perspective view of the projector when viewed from a front side, and FIG. 1B is a perspective view of the projector when viewed from a rear side. FIG. 2 is a bottom view of the projector. To simplify the description, arrows each indicating forward, rearward, leftward, and rightward directions, and arrows each indicating upward and downward directions are depicted in FIGS. 1A, 1B and FIG. 2. Hereinafter, the arrows indicating forward, rearward, leftward, and rightward directions are depicted in the same manner as above in the other drawings, as necessary.

The projector of the embodiment is a so-called short focus projector. Referring to FIGS. 1A and 1B, the projector is provided with a main body cabinet 1 having a substantially rectangular parallelepiped shape. The main body cabinet 1 is constituted of a lower cabinet 2, and an upper cabinet 3 which is placed on the lower cabinet 2 from above.

A top surface of the main body cabinet 1 is formed with a first slope 1a inclined downward and rearward, and a second slope 1b continuing from the first slope 1a and inclined upward and rearward. The second slope 1b faces obliquely upward and forward, and a projection port 4 is formed in the second slope 1b. Image light emitted obliquely upward and forward through the projection port 4 is enlarged and projected onto a screen disposed in front of the projector.

Further, the top surface of the main body cabinet 1 is formed with a lamp cover 5. The top surface of the main body cabinet 1 is formed with a lamp opening for use in exchanging a lamp unit, and a filter opening for use in exchanging a filter disposed in a fan unit for cooling the lamp unit. The lamp cover 5 is a cover for covering the lamp opening and the filter opening. Further, the top surface of the main body cabinet 1 is provided with an operation portion 6 constituted of a plurality of operation keys.

A terminal port portion 7 is formed in a right surface of the main body cabinet 1. A terminal panel 233 having various terminals such as AV terminals is attached to the terminal port portion 7. The terminal panel 233 constitutes a part of a control circuit unit to be described later. Audio Visual (AV) signals such as an image signal and an audio signal are inputted and outputted to and from the projector through the AV terminals. Further, an air inlet 8 is formed in the right surface of the main body cabinet 1 at a position above the terminal port portion 7. The air inlet 8 is constituted of multitudes of slit holes, and external air is drawn into the main body cabinet 1 through the air inlet 8.

A first air outlet 9 and a second air outlet 10 are formed in a left surface of the main body cabinet 1. Each of the first and second air outlets 9, 10 is constituted of multitudes of slit holes, and air inside the main body cabinet 1 is discharged to the outside of the projector through the first and second air outlets 9, 10. Further, a sound output port 11 is formed in a rear surface of the main body cabinet 1. Sounds in accordance with images are outputted through the sound output port 11 at the time of image projection.

Referring to FIG. 2, a fixed leg 12 is disposed in the middle of a front portion on a bottom surface of the main body cabinet 1, and two adjustable legs 13 are disposed at a rear end thereof. By expanding or contracting the two adjustable legs 13 up and down, it is possible to adjust the inclination of the main body cabinet 1 in forward/rearward directions and leftward/rightward directions. Thus, it is possible to adjust the upward/downward position and the leftward/rightward inclination of an image projected on a screen.

The projector of the embodiment may be installed in a suspended state from a ceiling with the main body cabinet 1 being upside down, other than an installation manner that the bottom surface of the main body cabinet 1 is placed on an installation plane such as a desk surface or a floor surface. Further, a front surface of the main body cabinet 1 is a flat surface without the terminal panel 233 and the air inlet 8. Accordingly, it is possible to install the projector of the embodiment in such a manner that the front surface of the main body cabinet 1 is placed on an installation plane. In this case, an image is projected on the installation plane itself.

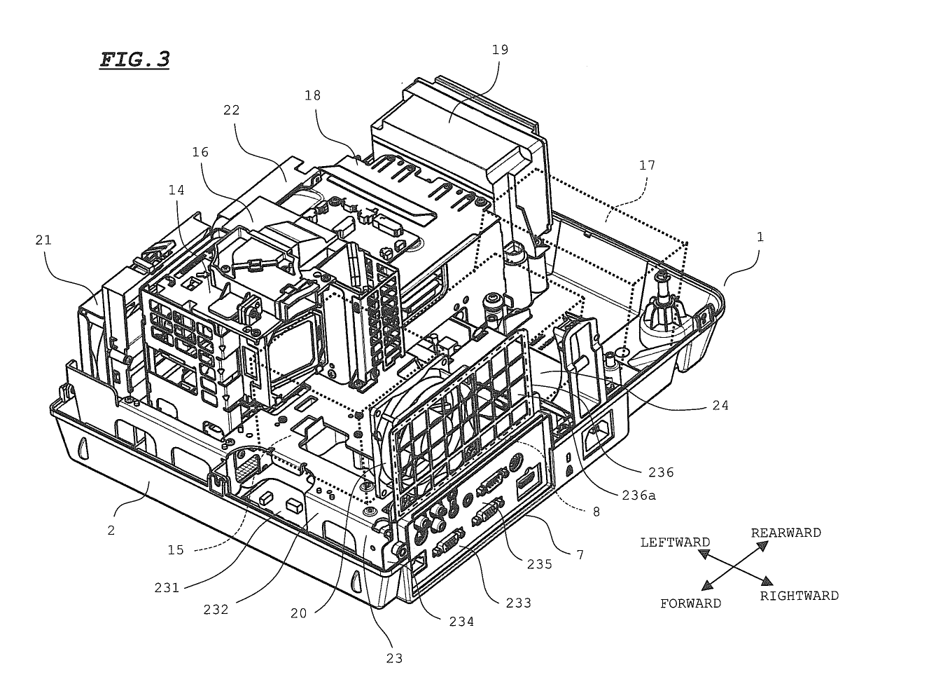

FIG. 3 is a diagram showing an internal structure of the projector. FIG. 3 is a perspective view showing a state that the upper cabinet 3 is detached, when viewed from a front side. To simplify the description, in FIG. 3, an imager unit 15 and a projection optical unit 17 are indicated by the dotted lines. Further, the position of the air inlet 8 is indicated by the one-dotted chain line.

Referring to FIG. 3, a lamp unit 14, and the imager unit 15 for modulating light from the lamp unit 14 to generate image light are disposed on a front portion of the lower cabinet 2.

The lamp unit 14 is constituted of a light source lamp, and a lamp holder for holding the light source lamp; and is configured so as to be detachably attached from above. A fan unit 16 is disposed behind the lamp unit 14. The fan unit 16 supplies external air (cooling air) drawn through the air inlet 8 to the light source lamp to cool the light source lamp. The lamp holder is formed with an air duct for guiding the cooling air from the fan unit 16 to the light source lamp.

The imager unit 15 includes a color wheel and a Digital Micromirror Device (DMD). The color wheel separates white light from the light source lamp into light of respective colors such as red, green, blue in a time-sharing manner. The DMD modulates the light of the respective colors emitted from the color wheel based on an image signal.

The projection optical unit 17 is disposed at a rear position of the imager unit 15. The projection optical unit 17 enlarges image light generated by the imager unit 15, and projects the enlarged image light onto a projection plane such as a screen.

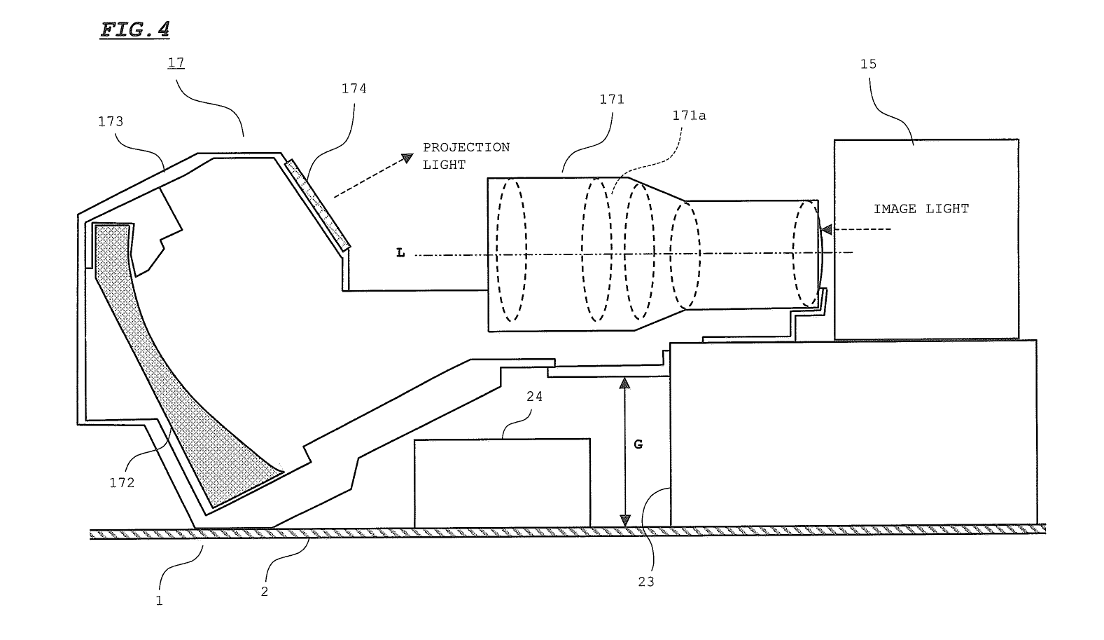

FIG. 4 is a diagram schematically showing an arrangement of the projection optical unit 17. In FIG. 4, the imager unit 15, a control circuit unit 23, and a noise filter unit 24 are schematically shown, in addition to the projection optical unit 17.

The projection optical unit 17 is constituted of a projection lens unit 171, a reflection mirror 172, and a housing 173 for housing the projection lens unit 171 and the reflection mirror 172. The projection lens unit 171 has a plurality of lenses 171a. The reflection mirror 172 is a curved mirror or a free curved mirror.

As shown in FIG. 4, image light emitted from the imager unit 15 is entered into the projection lens unit 171 at a position shifted from the optical axis L of the projection lens unit 171 in a direction toward the top surface of the main body cabinet 1. The entered image light receives a lens action by the projection lens unit 171, and is entered into the reflection mirror 172. Thereafter, the projection angle of the image light is expanded by the reflection mirror 172, and the image light is projected onto a projection plane (screen) via a light ray passage window 174.

As described above, image light is entered into the projection lens unit 171 at a position shifted from the optical axis L of the projection lens unit 171 in a direction toward the top surface of the main body cabinet 1. In view of this, the reflection mirror 172 is disposed at a position shifted from the optical axis L of the projection lens unit 171 toward the bottom surface of the main body cabinet 1. Here, the reflection mirror 172 has a reflection surface larger than the lens surface of each lens 171a constituting the projection lens unit 171. Accordingly, the shift amount of the reflection mirror 172 with respect to the optical axis L of the projection lens unit 171 is relatively large. Consequently, there is defined a relatively large space G between a lower surface of the projection lens unit 171 and the bottom surface of the main body cabinet 1 (lower cabinet 2). The space G is defined from the position where the projection lens unit 171 is disposed to the position where the imager unit 15 is disposed.

Referring back to FIG. 3, a power source unit 18 is disposed behind the fan unit 16. The power source unit 18 is provided with a power source circuit to supply electric power to each electric component of the projector. A speaker 19 is disposed behind the power source unit 18. Sounds outputted through the speaker 19 are released to the outside through the sound output port 11.

A DMD cooling fan 20 is disposed on the right of the imager 15. The DMD cooling fan 20 supplies external air drawn through the air inlet 8 to the imager unit 15 so as to cool the DMD. The DMD is sealably disposed in the imager unit 15, so that the DMD is kept from being directly contacted with the supplied external air.

A lamp exhaust fan 21 is disposed on the left of the lamp unit 14. The lamp exhaust fan 21 draws the air that has cooled the light source lamp, and discharges the air to the outside through the first air outlet 9.

A power source exhaust fan 22 is disposed on the left of the power source unit 18. The power source exhaust fan 22 draws warmed air inside of the power source unit 18, and discharges the warmed air to the outside through the second air outlet 10. By flowing the air from the inside of the power source unit 18 to the power source exhaust fan 22, fresh external air is supplied into the power source unit 18 through the air inlet 8.

As shown in FIG. 3 and FIG. 4, in the projector of the embodiment, the control circuit unit 23 and the noise filter unit 24 are disposed in the space G defined below the projection lens unit 171 and the imager unit 15.

The noise filter unit 24 is provided with a circuit board mounted with a noise filter and a fuse thereon, and supplies electric power inputted from a commercial AC power source to the power source unit 18 after noise removal.

The control circuit unit 23 includes a control circuit board 231, a holder 232 for holding the control circuit board 231, the terminal panel 233, and a fixing board 234 for fixing the terminal panel 233.

A control circuit for controlling various driving components such as a light source lamp and a DMD is mounted on the control circuit board 231. Further, various terminals 235 are mounted on the control circuit board 231.

The terminal panel 233 is formed with various openings of the shapes in accordance with the shapes of the terminals 235. The terminals 235 are exposed to the outside through the openings. Although not illustrated, the fixing board 234 is formed with openings through which the terminals 235 pass, as well as the terminal panel 233.

The fixing board 234 is made of a metal material, and a shielding portion 236 is formed on an upper portion thereof. The shielding portion 236 is formed with multitudes of openings 236a, and a metal mesh (not shown) is attached to each of the openings 236a. The shielding portion 236 is disposed on the inside of the air inlet 8 to block electromagnetic wave from leaking to the outside through the air inlet 8. External air drawn through the air inlet 8 is supplied to the inside of the main body cabinet 1 through the openings 236a.

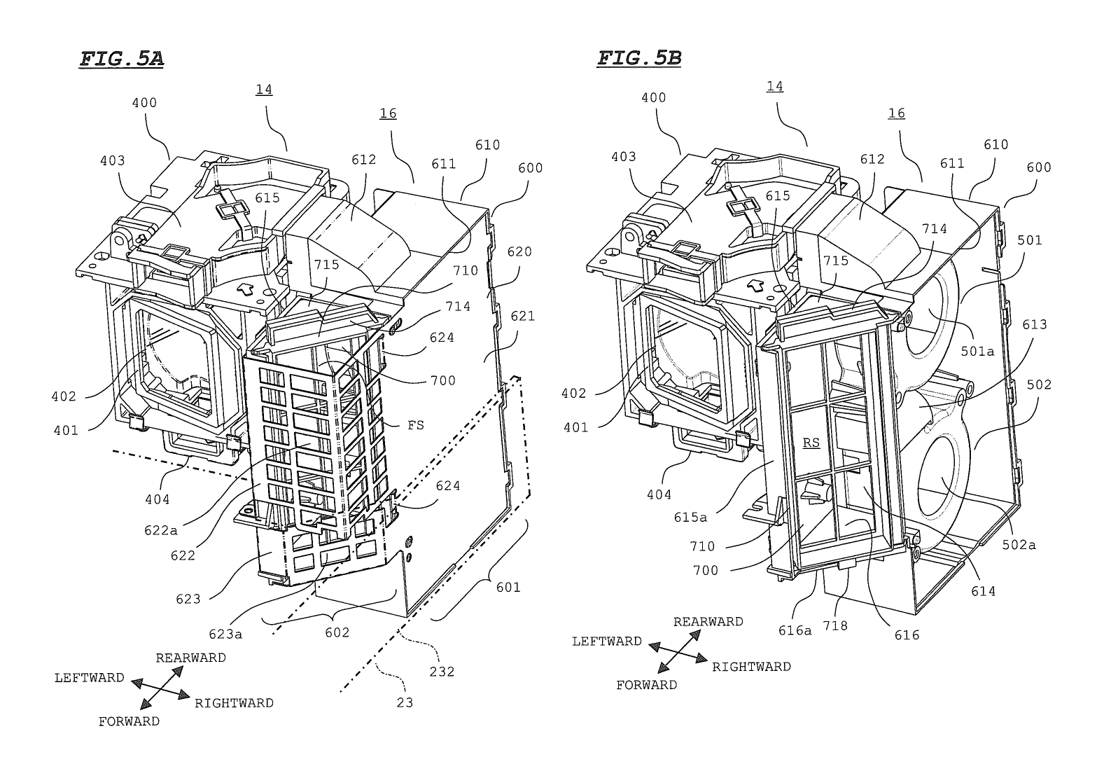

Next, an arrangement of the lamp unit 14 and the fan unit 16 is described in detail referring to FIGS. 5A to 9B.

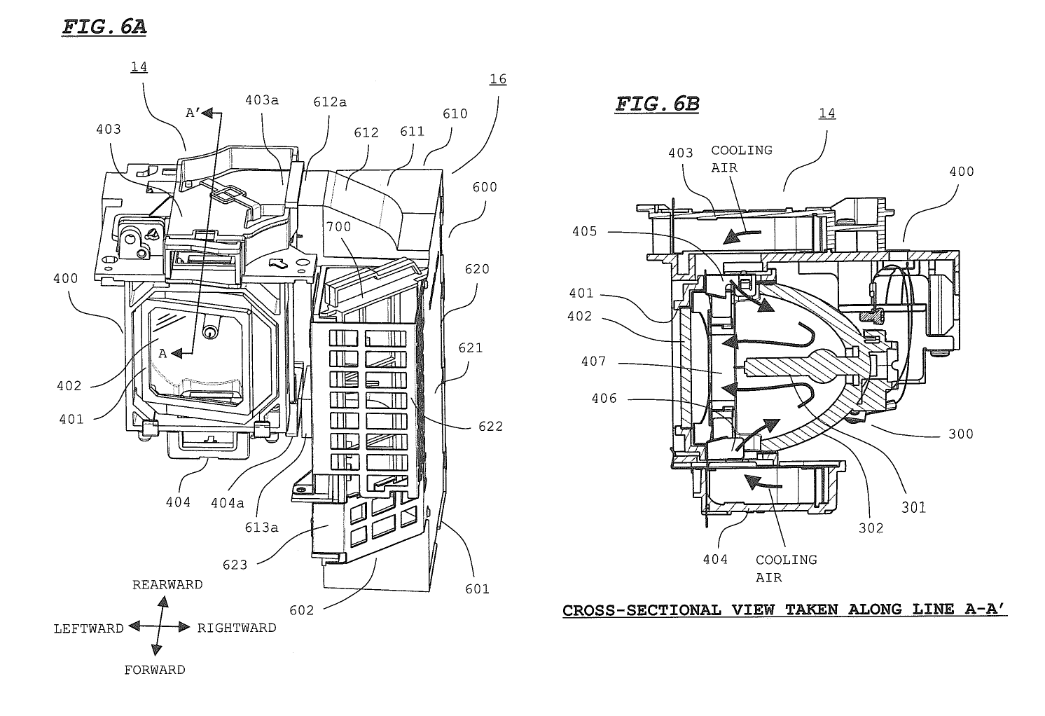

FIGS. 5A to 6B are diagrams showing an arrangement of the lamp unit 14 and the fan unit 16. FIG. 5A is a perspective view of the lamp unit 14 and the fan unit 16, when viewed from a front side. FIG. 5B is a perspective view of the lamp unit 14 and the fan unit 16 in a state that a casing cover 620 is detached, when viewed from a front side. FIG. 6A is a perspective view of the lamp unit 14 and the fan unit 16 when viewed from a further forward direction, as compared with the drawings of FIGS. 5A, 5B. FIG. 6B is a cross-sectional view taken along the line A-A′ in FIG. 6A. To simplify the description, a filter 720 constituting a filter unit 700 is not shown in FIGS. 5A, 5B, and FIG. 6A.

Referring to FIGS. 5A to 6B, the lamp unit 14 is constituted of a light source lamp 300, and a lamp holder 400 for holding the light source lamp 300.

The light source lamp 300 is provided with a luminous tube 301 and a reflector 302 (see FIG. 6B). A metal halide lamp is used as the luminous tube 301. Alternatively, a lamp such as an ultra-high pressure mercury lamp or a xenon lamp may be used as the luminous tube 301, in place of the metal halide lamp. The reflector 302 has an inner surface thereof formed into a parabolic shape, and reflects white light emitted from the luminous tube 301 on the inner surface to guide the reflected light in a forward direction.

A front surface of the lamp holder 400 is formed with an emission window 401 through which light from the light source lamp 300 is emitted. A heat resistant glass plate 402 is mounted in the emission window 401. A rear surface of the lamp holder 400 is formed into an opening, and the light source lamp 300 is mounted in the opening from a rear side.

An upper portion and a lower portion of the lamp holder 400 are respectively formed with an upper duct 403 and a lower duct 404. Further, as shown in FIG. 6B, an upper outlet 405 communicating with the upper duct 403 and a lower outlet 406 communicating with the lower duct 404 face to the inside of the reflector 302. Further, a middle portion of the lamp holder 400 is formed with a discharge port 407 on both of left and right sides thereof. In FIG. 6B, only the left discharge port 407 is shown out of the left and right discharge ports 407.

An unillustrated mesh member is disposed in each of the inside of the upper duct 403, the inside of the lower duct 404, and the left and right discharge ports 407. The provision of the mesh members enables to prevent pieces of the luminous tube 301 from coming out of the lamp holder 400 in case of breakage of the luminous tube 301.

The fan unit 16 is provided with two lamp cooing fans 501, 502, a fan casing 600 for housing the lamp cooling fans 501, 502, and the filter unit 700 to be mounted in the fan casing 600.

The lamp cooling fans 501, 502 are a centrifugal fan. Inlets 501a, 502a are formed in end surfaces of the lamp cooling fans 501, 502, and outlets (not shown) are formed in outer peripheral surfaces thereof.

The fan casing 600 is provided with two members i.e. a casing body 610 made of a resin and the casing cover 620 made of a metal. With the provision of the casing body 610 and the casing cover 620, the fan casing 600 is formed with a fan housing portion 601, and a filter housing portion 602 formed in the forward side of the fan housing portion 601. The cooling fans 501, 502 are housed in the fan housing portion 601, and the filter unit 700 is housed in the filter housing portion 602.

The fan housing portion 601 has a substantially rectangular parallelepiped shape. On the other hand, the filter housing portion 602 has a hollow prismatic shape with a substantially rectangular shape in cross section, with a top surface thereof formed into an opening and a bottom surface. A lower end of the filter housing portion 602 is formed into an inclined surface at portions corresponding to a right surface and a front surface thereof, and is configured into a hollow prismatic shape approximate to a triangular shape in cross section. The filter housing portion 602 has such a size as to allow insertion of a nozzle of a cleaner from above. For instance, the top surface opening of the filter housing portion 602 has a size of about 40 mm in forward and rearward directions and about 40 mm in transverse direction.

The casing body 610 has a case 611 with a left surface thereof being formed into an opening. The two lamp cooling fans 501, 502 are fixedly stacked one over the other in the case 611.

A first duct 612 is formed in an upper portion of the case 611. An entrance of the first duct 612 faces to the inside of the case 611, and communicates with the outlet of the lamp cooling fan 501. Further, a second duct 613 is formed in the middle portion of the case 611. An entrance of the second duct 613 faces to the inside of the case 611, and communicates with the outlet of the lamp cooling fan 502.

As shown in FIG. 6A, an exit 612a of the first duct 612 adjacently opposes an entrance 403a of the upper duct 403 of the lamp holder 400, and an exit 613a of the second duct 613 adjacently opposes an entrance 404a of the lower duct 404 of the lamp holder 400.

A front surface of the case 611 is formed with an intake port 614. The front surface of the case 611 is formed with a left surface portion 615 constituting a left surface of the filter housing portion 602, and a bottom surface portion 616 constituting a bottom surface of the filter housing portion 602. A front end of the left surface portion 615 is bent rightward to thereby form a corner portion 615a.

The casing cover 620 is formed with a case cover member 621, a first filter cover member 622, and a second filter cover member 623. The case cover member 621 covers a right surface of the case 611. The first filter cover member 622 extends forward from the case cover member 621, is bent at a right angle, and then extends leftward. The first filter cover member 622 constitutes the right surface and the front surface of the filter housing portion 602. The second filter cover member 623 extends slightly forward from the case cover member 621, extends obliquely leftward in forward direction, and then extends rightward. The second filter cover member 623 constitutes the lower end of the filter housing portion 602. The first filter cover member 622 and the second filter cover member 623 are respectively formed with air inlets 622a, 623a each constituted of plural openings substantially over the entirety thereof.

Further, the casing cover 620 is formed with two guide pieces 624 which protrude to the inside of the filter housing portion 602 at two positions away from each other in vertical direction.

As shown in FIG. 5A, the fan unit 16 is fixed to a holder 232 of a control circuit unit 23. In this state, a lower part of the first filter cover member 622 is covered by a top surface of the holder 232.

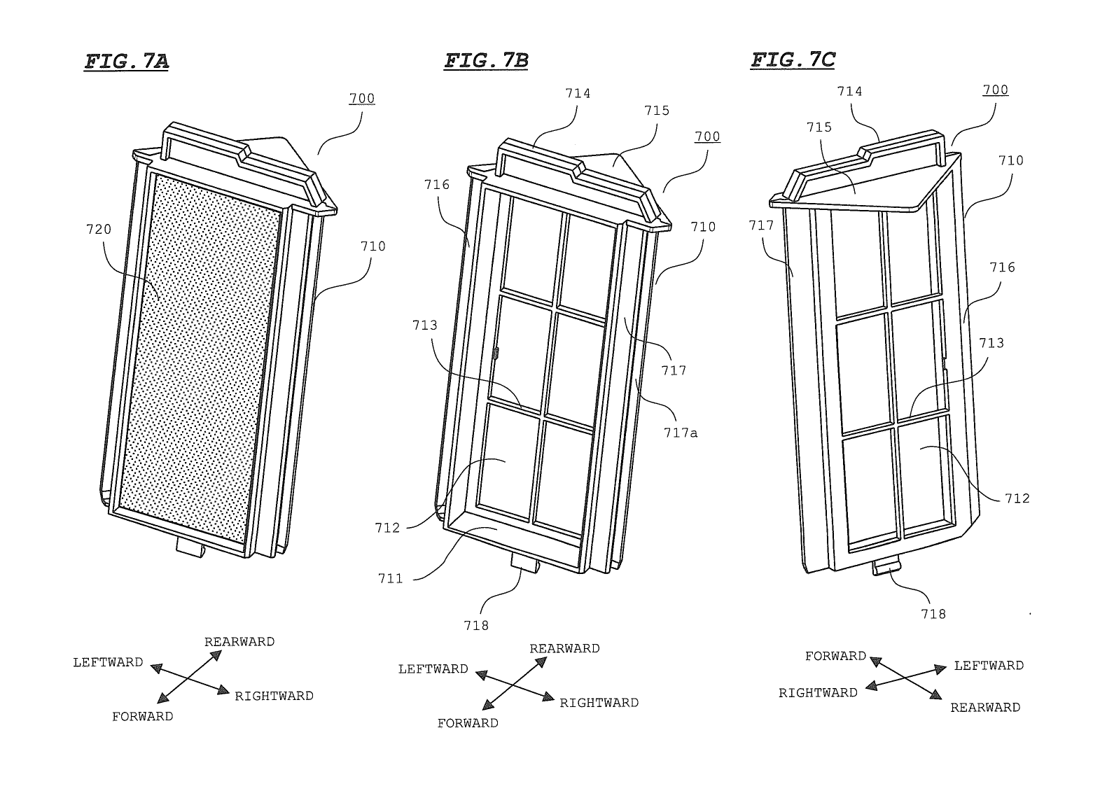

FIGS. 7A and 7B are diagrams showing an arrangement of the filter unit 700. FIGS. 7A, 7B are perspective views of the filter unit 700, when viewed from a front side, and FIG. 7C is a perspective view of the filter unit 700, when viewed from a rear side. FIG. 7A shows a state that the filter 720 is attached, and FIGS. 7B, 7C show a state before the filter 720 is attached.

Referring to FIGS. 7A to 7C, the filter unit 700 is constituted of a filter holder 710, and the filter 720 to be attached to the filter holder 710.

The filter holder 710 is formed with a housing recess 711 in which the filter 720 is housed. A bottom surface of the housing recess 711 is formed with an air vent 712. The air vent 712 is formed with a lattice 713.

A handle 714 is formed on an upper end of the filter holder 710. A substantially triangular-shaped cover member 715 is formed at a rear of the handle 714. A left end of the filter holder 710 is formed with a left guide portion 716. The left guide portion 716 has a shape corresponding to the shape of the corner portion 615a of the filter housing portion 602. Further, a right end of the filter holder 710 is formed with a right guide portion 717. The right guide portion 717 is formed with a guide groove 717a extending in vertical direction. Further, a lower end of the filter guide 710 is formed with a tab 718.

The filter 720 is a polyurethane filter having a rectangular shape. The filter 720 is fixed to the housing recess 711 by e.g. an adhesive agent. Alternatively, the filter 720 may be a filter made of a material other than polyurethane, such as a non-woven fabric filter.

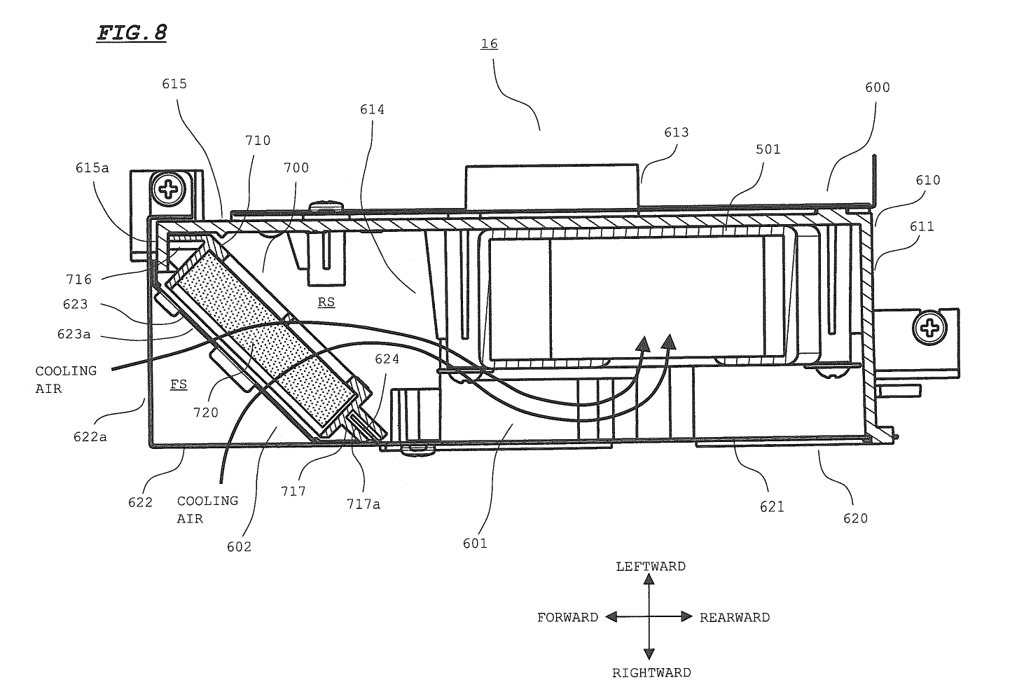

FIG. 8 is a cross-sectional view of the fan unit 16 taken in the horizontal direction at the position of the upper guide piece 624.

The filter unit 700 is housed in the filter housing portion 602 from above, and is disposed at a substantially diagonal position in the filter housing portion 602, when viewed from above. Specifically, the filter unit 700 is disposed at a front position of the intake port 614 of the fan housing portion 601 and diagonally with respect to the intake port 614.

In housing the filter unit 700 in the filter housing portion 602, the left guide portion 716 of the filter holder 710 is guided along the corner portion 615a of the filter housing portion 602. Further, the right guide portion 717 of the filter holder 710 is guided by the two guide pieces 624, while the two guide pieces 624 being inserted into the guide groove 717a of the right guide portion 717.

In this way, in a state that the filter unit 700 is housed in the filter housing portion 602, a hollow first space FS is formed on the air flow-in side of the filter unit 700, and a hollow second space RS is formed on the air flow-out side of the filter unit 700 within the filter housing portion 602. Further, as shown in FIG. 5B, an opening above the second space RS is covered by the cover member 715 of the filter holder 710.

Further, when the filter unit 700 is housed in the filter housing portion 602, as shown in FIG. 5B, the tab 718 of the filter holder 710 is engaged with an end 616a of the bottom surface portion 616 of the filter housing portion 602. The engagement makes the filter unit 700 difficult to move upward. When an external upward force of a certain degree is applied to the filter unit 700, the engagement between the tab 718 and the end 616a is released. Then, the filter unit 700 is detached upward.

When the projector is run, the lamp cooling fans 501, 502 are driven. Further, the DMD cooling fan 20, the lamp exhaust fan 21, and the power source exhaust fan 22 are driven. Upon the driving, external air is drawn to the inside of the main body cabinet 1 through the air inlet 8.

FIG. 8 shows a stream of cooling air in the fan unit 16 by the arrows. External air drawn to the inside of the main body cabinet 1 flows into the filter housing portion 602 through the air inlets 622a, 623a as cooling air. The cooling air that has flowed into the filter housing portion 602 passes through the filter 720. At the passing, dust and fume contained in the cooling air are blocked by the filter 720 and adhered to the filter 720. The cooling air after removal of dust and the like by the filter 720 flows into the fan housing portion 601 through the intake port 614, and is supplied to the lamp cooling fans 501, 502.

As described above, the opening above the second space RS is covered by the cover member 715 by the attachment of the filter unit 700 (see FIGS. 5A and 5B). This prevents cooling air from being supplied to the fan housing portion 601 through any other fluid channel except for the fluid channel through the filter unit 700 to thereby supply clean cooling air to the lamp unit 14. Since an area above the first space FS on the air flow-in side of the filter unit 700 is opened, cooling air is supplied through the opening.

Cooling airs blown out from the lamp cooling fans 501, 502 respectively flow into the upper duct 403 and the lower duct 404 of the lamp holder 400 through the first duct 612 and the second duct 613.

FIG. 6B shows a stream of cooling air in the lamp unit 14 by the arrows. Cooling air that has flowed into the upper duct 403 reaches the upper outlet 405 through the upper duct 403, and then is supplied to the inside of the reflector 302 of the light source lamp 300 through the upper outlet 405. Further, cooling air that has flowed into the lower duct 404 reaches the lower outlet 406 through the lower duct 404, and is supplied to the inside of the reflector 302 through the lower outlet 406. By the cooling airs that have been supplied into the reflector 302 through the upper and lower ducts 403, 404, the reflector 302 is cooled inwardly. After the cooling, the air in the reflector 302 is discharged to the outside of the lamp unit 14 through the discharge port 407.

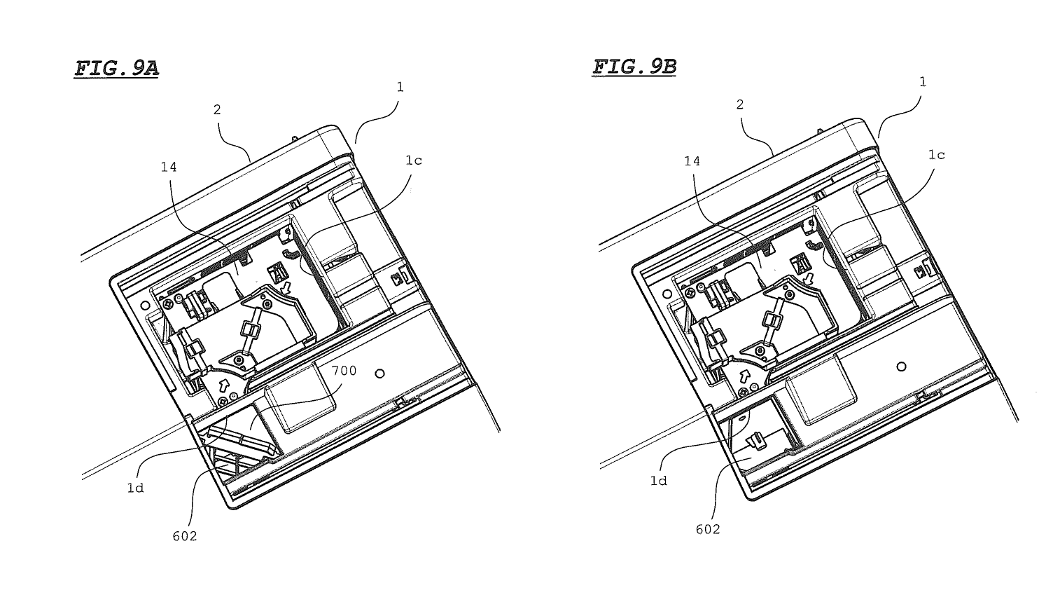

FIGS. 9A and 9B are perspective views of essential parts of the projector in a state that the lamp cover 5 is detached, when viewed from above. FIG. 9A shows a state that the filter unit 700 is housed in the filter housing portion 602. FIG. 9B shows a state that the filter unit 700 is detached from the filter housing portion 602.

A top surface of the main body cabinet 1 (upper cabinet 3) is formed with a lamp opening 1c. The lamp opening 1c is positioned immediately above the lamp unit 14, and has such a size that the lamp unit 14 can be taken in and out of the main body cabinet 1. The lamp unit 14 is housed in the main body cabinet 1, or taken out of the main body cabinet 1 through the lamp opening 1c.

The top surface of the main body cabinet 1 is further formed with a filter opening 1d. The filter opening 1d is positioned immediately above the filter housing portion 602, and has a size substantially the same as the size of the top surface opening of the filter housing portion 602. The filter unit 700 is housed in the filter housing portion 602, or taken out of the filter housing portion 602 through the filter opening 1d.

When the filter 720 is clogged, for instance, the projector outputs an alert indicating the clogging. Then, the user is allowed to detach the lamp cover 5, and take out the filter unit 700 from the filter housing portion 602 to clean the filter unit 700.

As described above, the filter housing portion 602 is formed with the first space FS of relatively large dimensions on the air flow-in side of the filter unit 700 (between the filter unit 700 and the first filter cover member 622) (see FIG. 8). Accordingly, there is no or less likelihood that dust and the like adhered to a front surface of the filter 720 may be scraped by the first filter cover 622 (by the right surface and the front surface of the filter housing portion 602) in taking out the filter unit 700, thereby suppressing falling of the dust and the like from the filter unit 700.

However, a space between the front surface of the filter 720 and the second filter cover member 623 is narrow at the lower end of the filter housing portion 602. As a result, the adhered dust and the like may be contacted with the second filter cover member 623 on a very small area (lower end) on the front surface of the filter 720. Further, a certain degree of impact may be applied to the filter unit 700 in taking out the filter unit 700 due to e.g. disengagement between the tab 718 and the end 616a of the bottom surface portion 616. As a result, the dust and the like adhered to the front surface of the filter 720 may fall onto a bottom portion of the filter housing portion 602 in detaching the filter unit 700.

As described above, in the embodiment, the filter housing portion 602 is formed into a hollow prismatic shape with a substantially rectangular shape in cross section. Accordingly, as shown in FIG. 9B, a large space defined by communication between the first space FS and the second space RS is secured in the filter housing portion 602, after the filter unit 700 is taken out. Thus, even if dust and the like may fall in the filter housing portion 602, the user is allowed to insert the nozzle of a cleaner into the filter housing portion 602 (into the first space FS and/or the second space RS) through the filter opening 1d to thereby vacuum the dust and the like from the bottom portion by the cleaner.

As described above, in the embodiment, the fan unit 16 is provided with the filter unit 700, and dust and the like contained in air are removed by the filter unit 700 in supplying the air drawn to the inside of the main body cabinet 1 to the inside of the fan unit 16. With the dust removal, it is possible to prevent the lamp unit 14 from an influence of dust and the like. For instance, it is possible to prevent adhesion of dust and the like to the mesh members disposed in the inside of the upper duct 403, the inside of the lower duct 404, and the left and right discharge ports 407, which may resultantly lower the flow rate of cooling air to the light source lamp 300 and overheat the light source lamp 300.

Further, in the embodiment, the filter unit 700 in accordance with an air intake amount of the fan unit 16 may be used. This enables to reduce the size of the filter unit 700, as compared with an arrangement that the filter unit 700 is disposed in the air inlet 8. Consequently, it is possible to reduce the cost.

Furthermore, in the embodiment, the imager unit 15 is configured such that the DMD is not contacted with air drawn through the air inlet 8. In this arrangement, since there is no need of removing dust and the like from the members to be cooled other than the lamp unit 14, a filter in the air inlet 8 can be omitted. This enables to simplify the arrangement and reduce the cost.

In addition, in the embodiment, the fan unit 16 is formed with the filter housing portion 602 for detachably housing the filter unit 700 therein. Further, the main body cabinet 1 is formed with the filter opening 1d. With this arrangement, in the case where the filter unit 700 is clogged, the user is allowed to detach the filter unit 700 from the filter housing portion 602 through the filter opening 1d. This allows the user to easily clean or exchange the filter unit 700.

Furthermore, in the embodiment, the filter unit 700 is disposed at a front position of the intake port 614 of the fan housing portion 601 and diagonally with respect to the intake port 614. With this arrangement, since the area of the filter unit 700 can be made large with respect to the intake port 614, it is possible to extend the life (use time) of the filter unit 700.

Furthermore, in the embodiment, since dust and the like can be easily removed, even if the dust and the like may be accumulated on the bottom portion of the filter housing portion 602, it is possible to keep the inside of the projector clean.

The embodiment of the invention has been described as above. The invention is not limited to the foregoing embodiment. Further, the embodiment of the invention may be changed or modified in various ways other than the above, as necessary, as far as such changes and modifications do not depart from the scope of the claims of the invention.

For instance, in the embodiment, the filter housing portion 602 is opened upward, the filter opening 1d is formed in the top surface of the main body cabinet 1, and the filter unit 700 is housed in the filter housing portion 602 through the filter opening 1d. Alternatively, the filter housing portion 602 may be opened downward, the filter opening 1d may be formed in the bottom surface of the main body cabinet 1, and the filter unit 700 may be housed in the filter housing portion 602 through the filter opening 1d formed in the bottom surface of the main body cabinet 1.

Further, in the embodiment, the filter unit 700 is disposed diagonally with respect to the intake port 614 of the fan housing portion 601. The filter unit 700 is not necessarily disposed diagonally. Alternatively, for instance, the filter unit 700 may be disposed at a front position of the intake port 614 and in parallel to the intake port 614.

Furthermore, in the embodiment, a DMD is used as an imager constituting the imager unit 15. Alternatively, a liquid crystal panel may be used.

In addition, in the embodiment, the lamp unit 14 having a light source lamp is used. Alternatively, a light source other than the lamp light source, such as a laser light source or an LED light source may be used.

The embodiment of the invention may be changed or modified in various ways as necessary, as far as such changes and modifications do not depart from the scope of the claims of the invention.

The expression “a top surface of the main body cabinet” in claim 3 indicates a surface facing upward, in the case where a projection display device is fixedly installed. However, in the case where a projection display device is configured such that image light is bent on a reflection mirror, as described in the embodiment, “a top surface of the main body cabinet” indicates a surface facing upward, in the case where the projection display device is placed on an installation plane such as a floor surface or a desk surface, and an image is projected onto a projection plane perpendicular to the installation plane.

What is claimed is:

1. A projection display device, comprising:
a main body cabinet including an air inlet;
a light source unit which is disposed in the main body cabinet; and
a cooling unit which is disposed adjacent to the light source unit, and cools the light source unit, wherein
air drawn to an inside of the main body cabinet through the air inlet is drawn to an inside of the cooling unit, and is supplied to the light source unit, and
the cooling unit is provided with a filter section which removes unwanted matters from the air drawn to the inside of the cooling unit.

2. The projection display device according to claim 1, wherein
the cooling unit is formed with a filter housing portion which detachably houses the filter section therein, and
the main body cabinet is formed with an opening which passes the filter section therethrough in detaching the filter section from the filter housing portion.

3. The projection display device according to claim 2, wherein
the filter housing portion detachably houses the filter section from a top surface side of the main body cabinet, and
the opening is formed in a top surface of the main body cabinet.

4. The projection display device according to claim 1, wherein
the cooling unit includes an intake port which takes in air that has passed through the filter section, and
the filter section is disposed at a front position of the intake port and diagonally with respect to the intake port.
